(19) United States
(12) Patent Application Publication
(10) Pub. No.: US 2009/0063045 A1
(43) Pub. Date: Mar. 5, 2009

(54) GPS BASED FUEL EFFICIENCY OPTIMIZER

(75) Inventors: JOSEPH N. FIGUEROA, Kirkland, WA (US); Brigette Huang, Woodinville, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/848,000

(22) Filed: Aug. 30, 2007

(51) Int. Cl. G01C 21/30

(52) U.S. Cl. 701/210

(57) ABSTRACT

Routing options for fuel efficient use of a motor vehicle employing a GPS-based navigation system are computed based on travel information and external data. A navigation device receives route input from a driver or by recording a travelled route. External data such as traffic conditions, weather conditions, actual fuel consumption, road blockages, traffic light configurations, and the like is received from one or more networked information sources. A fuel efficient route based on the original route and the received external data is computed for the whole route or individual sections between stops on the route for display to the driver. Fuel efficient route(s) may be recomputed with up-to-date external data upon driver request, predefined intervals, or updates to external data.

### BACKGROUND

Motor vehicle users are increasingly sensitive to their vehicle fuel costs. Environmental consciousness is also another factor that is leading people to search for efficient use of their vehicles and reduction of fuel consumption. One of the least efficient methods of driving is in-city driving with numerous stops due to traffic lights, heavy traffic, prolonged waits at railroad crossings or draw-bridges. While drivers can get up-to-date traffic information from radio stations or wireless services, it is often difficult to determine an efficient route based on all the information available. The route with the least amount of traffic may not always be the most fuel efficient route due to other factors such as number of traffic lights, speed limit on portions of the selected route, and the like.

Global Positioning System (GPS) based navigation devices are commonly used by drivers to navigate in areas, where they may not be familiar with the streets and landmarks. A GPS-based navigation device typically receives positioning data from a satellite, compares the data to a map in its memory and provides the driver with a map of the area and directions for a selected destination. However, GPS-based navigation devices often require a user to undergo a non-trivial learning curve before the device provides value to them (e.g., learning to enter destination address and distance/time optimization parameters). Moreover, drivers are unlikely to use the navigation features to get to destinations they already know such as the local post-office, bank, grocery store, etc.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are directed to providing routing options for fuel efficient use of a motor vehicle employing a GPS-based navigation system. A navigation device according to embodiments may be configured to receive up-to-date data on traffic conditions such as traffic levels, railroad or bridge opening times, traffic light configurations, and the like, and compute one or more fuel efficient routes for the driver. The route may be computed based on driver input for destination(s) or previously recorded routes. The route option(s) may then be presented to the driver through a display or other means.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an example map with typical destinations for a driver, where a GPS-based fuel efficiency optimizer may be employed to determine routes for optimum fuel consumption;

FIG. 2 illustrates an example GPS-based navigation device with fuel efficiency optimization capability;

FIG. 3 is an example networked environment, where embodiments may be implemented;

FIG. 4 is a block diagram of an example computing operating environment, where embodiments may be implemented; and

FIG. 5 illustrates a logic flow diagram for a process of facilitating fuel efficiency optimization employing GPS-based navigation.

### DETAILED DESCRIPTION

As briefly described above, drivers may be provided fuel efficient routing options employing GPS-based navigation. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

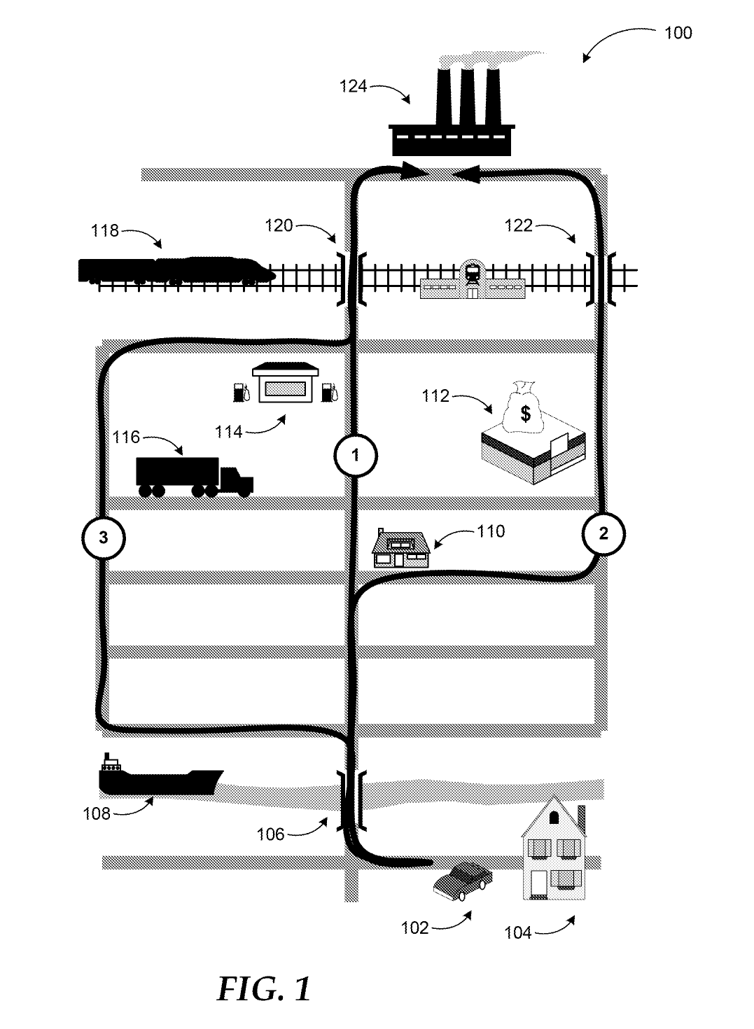

Referring to FIG. 1, an example map 100 is illustrated with typical destinations for a driver, where a GPS-based fuel efficiency optimizer may be employed to determine routes for optimum fuel consumption. While a GPS-based fuel efficiency optimization system may be implemented in any geography, an example map is used to illustrate features of such a system in FIG. 1.

As described previously, optimizing fuel efficiency is a desired goal for many drivers today. Many factors, especially in in-city driving, can affect how fuel is consumed. Such factors include traffic conditions, vehicle characteristics, seasonal weather, and even driving habits of a driver. While GPS-based navigation systems can provide navigational information and information sources such as radio stations are available for up-to-date traffic conditions, determining a personalized route for a driver based on fuel efficiency is a difficult challenge.

According to an example scenario, a driver at their home may decide to run a few errands at the bank, grocery store, and post-office on their way to work. Based on the stops on the way, there may be a number of possible routes. While some routes may be time-efficient or easier to drive (surface streets instead of a freeway, etc.), fuel efficiency for each route may vary significantly. For example, the shortest route may not necessarily be the most fuel efficient route due to the timing of traffic signals on the route, posted speed limits for the streets, and so on.

As shown on the example map, a driver using their car (102) may leave their house (104) and first go over draw-bridge 106. The draw-bridge 106 may open at specific times of the day or when a ship 108 arrives for passage. For fuel efficiency, the driver may have to choose a further away bridge (not shown), if the draw-bridge 106 is open when the driver is expected to cross. Depending on the stops between house 104 and workplace 124, the driver may take one the example routes 1, 2, or 3.

While route 1, appears to be the shortest route, it may not be the most fuel efficient because the draw-bridge 106 and the railroad crossing 120 may cause significant delays with the car waiting in idle. Route 2 may appear to be a longer route with a post office 110 and bank 112 on the way, but railroad crossing 122 may be a more efficient crossing since it is behind a train station. Route 3 may appear to be a longer route to arrive at workplace 124 passing through gas station 114, but there may be fewer traffic lights and less delay on that route compared to others.

The efficiency of each route for fuel consumption may change, of course, depending on other factors such as those listed above. A GPS-based navigation device according to embodiments may first determine a driver's routes based on driver input or recording while driving, receive data for computing fuel efficiency such as traffic conditions, bridge and railroad crossing openings, and the like, and compute the most fuel efficient routes providing them to the driver as options. The driver may also be given the option of storing the routes as favorites for future use. Favorite routes may be updated based on up-to-date information or driver request.

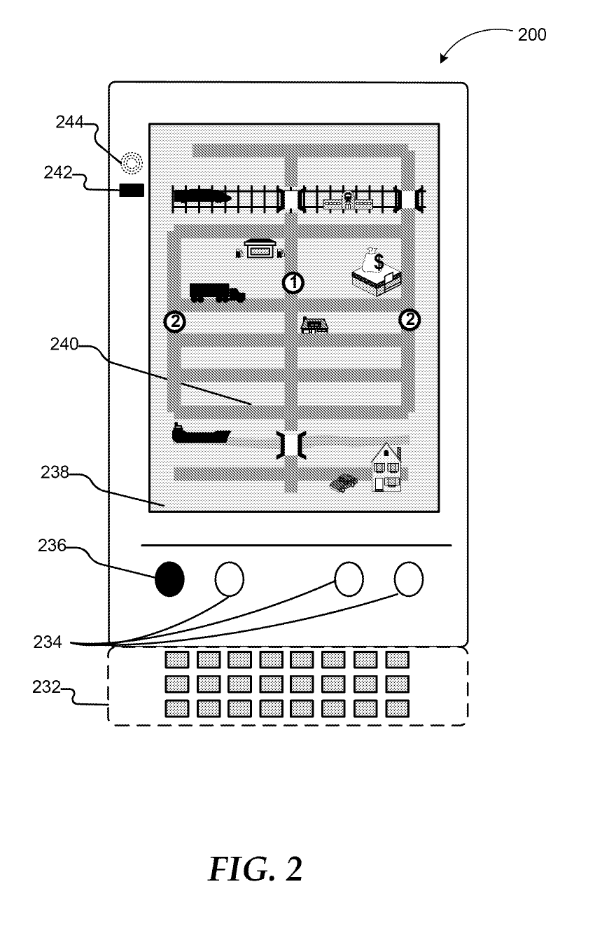

FIG. 2 illustrates an example GPS-based navigation device with fuel efficiency optimization capability. Navigation device 200 is an example illustration. A GPS-based navigation device with fuel efficiency optimization capability may be implemented in many ways including as an integrated module in another portable device such as a smart phone, a Personal Digital Assistant (PDA), a smart automobile console, or in any other form. As such, a GPS-based navigation device with fuel efficiency optimization capability according to embodiments may include additional or fewer components and features than those shown here.

Example navigation device 200 includes typical components of a mobile communication device such as a hard keypad 232, specialized buttons (“function keys”) 234, display 238, and one or more indicators (e.g. LED) 242. Navigation device 200 may also include a speaker 244 for voice communications (e.g. voice-based directions for efficient routes). Display 238 may be an interactive display (e.g. touch sensitive) and provide soft keys as well.

To initiate recording of a route, one or more hard or soft keys (e.g. hard key 236) may be used as dedicated triggers. One of the function keys 234 or a soft key may also be used to trigger computation of a fuel efficient route by the navigation device 200. In addition to the graphical user interface (GUI) 240 of a navigation application, display 238 may also show user interfaces of other applications such as a fuel consumption computation application, a traffic conditions display application, and the like. Furthermore, navigation device 200 may also include standard electronic mail or voice communication features as well.

Navigation device 200 may be configured to store a number of routes for the driver. This may be done by the driver entering landmarks or addresses of the origin of travel, the destination, and any stops along the route. According to another embodiment, the driver may press “record” button 236 and let the device record the route during travel. The routes may then be stored in a local or remote non-volatile storage. According to a further embodiment, the driver may be enabled to associate each route with a user-friendly name for easy recollection. According to yet another embodiment, the device may be associated with a scheduling (or calendaring) application such that recording of the route(s) and/or computation may be performed automatically based on predefined appointments (e.g. before a recurring appointment that requires a trip).

Upon completion of the first travel through a route, the driver may press a “compute fuel efficient route” button (e.g. one of the function keys 234) enabling the navigation device to execute an efficient route computation algorithm using the factors listed previously that include external data. Navigation device 200 may also compute the efficient route automatically upon completion of the travel (e.g. a predefined period after the completion of the first travel through the route).

The computation algorithm may include one or more of the following steps: (1) compute route “stops” by determining if there are any predefined intervals (e.g. 5 minutes) where the latitude and longitude data points did not change more than a predefined tolerance value (e.g. 5 meters); (2) list the different ordered “stop” permutations; (3) for each “stop permutation” use compute the fastest route through each “stop” in a particular route permutation; (4) represent each “stop” as a vertex in an undirected graph where each of the computed routes between each “stop” is represented as a segment in the graph; (5) associate a value with each segment with a number that is the weighted average between the travel times computed previously and predicted by external data such as a Smartphlow-like algorithm if traffic data is available; (6) compute a solution using the undirected graph as input; and (7) display the route.

The computation of “stops” may take other factors into consideration for accuracy. For example, when more than a predefined interval of motionlessness is detected, the coordinates may be checked against road locations to prevent a traffic jam stop from being counted as a real stop. Another alternative may determine a stop based on when the engine is turned off and the location is not the driver's residence.

The solution to be computed is essentially a solution of the travelling salesman problem. The traveling salesman problem is a problem in discrete or combinatorial optimization. It is a prominent illustration of a class of problems in computational complexity theory. Mathematical problems related to the traveling salesman problem date back to early 1800's and there are many solution algorithms.

The generalized problem is basically: given a number of destinations and the costs of traveling from any destination to any other destination, what is the cheapest round-trip route that visits a number of predefined destinations once and then returns to the origination point? A size of the solution space is (n-1)!/2, where n is the number of destinations. This is also the total number of cycles with n different nodes that one can form in a complete graph of n nodes.

An equivalent formulation in terms of graph theory is: given a complete weighted graph (where the vertices would represent the destination, the edges would represent the roads, and the weights would be the cost or distance of that road), find a Hamiltonian cycle with the least weight. It can be shown that the requirement of returning to the origination point does not change the computational complexity of the problem.

Algorithms for finding exact solutions such as branch-and-bound algorithms and progressive improvement algorithms may be employed for the solution. Suboptimal or heuristic algorithms may also be employed for the solution. These include various approximation algorithms, nearest neighbor (NN) algorithm, pairwise exchange or Lin-Kernighan heuristics, Markov chains, and the like.

Navigation device 200 may provide a fuel efficient route for a combination of stops and/or individual fuel efficient routes between stops. Navigation device 200 may receive up-to-date external data such as traffic conditions, actual vehicle fuel consumption and the like through local communications or remote communications over networks. Thus, navigation device 200 may include wired and wireless communication capabilities such as serial communications, parallel communications, Wireless Local Area Network (WLAN) communications, Wide Area Network (WAN) communications, cellular network communications, and the like.

Fuel efficient routes may be updated based on a time of day, a trigger associated with the driver (e.g., the driver starting the car, pressing a button, and the like), on predefined intervals, or receipt of up-to-date data. As mentioned previously, fuel efficient routes may be stored with an associated user-friendly name making it easier for the driver to recall a route.

While specific computation methods and algorithms have been listed above, these are examples for illustration purposes only. Determining an optimized fuel efficiency route for a driver using GPS-based navigation may be implemented employing other algorithms, fewer or additional steps, and the like.

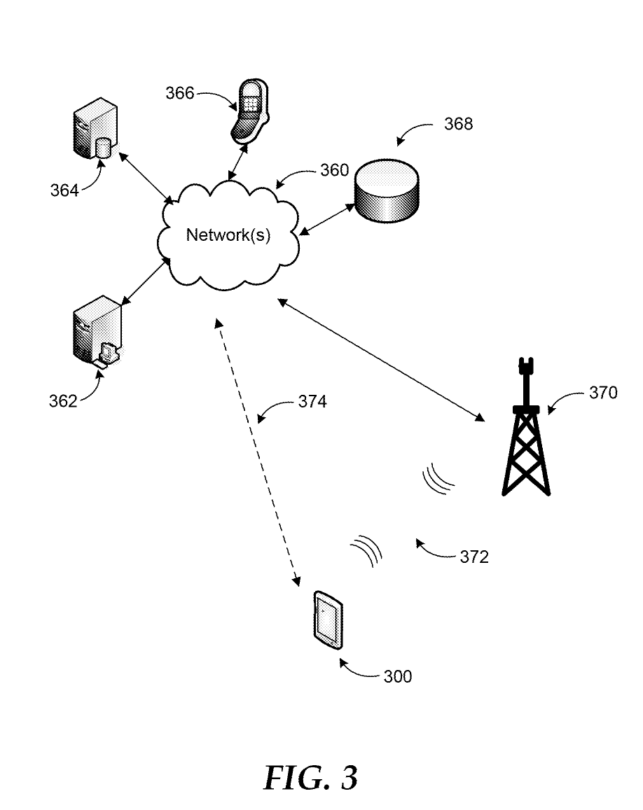

FIG. 3 is an example networked environment, where embodiments may be implemented. Navigation device 300 receives data through two main channels: navigational data through a GPS satellite (not shown) and external data through a network communication. Local data such as actual vehicle fuel consumption may also be received through local communications with the vehicle computer system.

The external data, which may include traffic conditions, road blockages, bridge/railroad crossing openings, traffic light configurations, and the like may be provided from a networked system such as network(s) 360.

Network(s) may facilitate a number of devices and applications implemented in un-clustered systems or clustered systems to collect input for external data and provide the data to navigation devices. Such a system may comprise any topology of servers, clients, Internet service providers, and communication media. Also, the system may have a static or dynamic topology. The term “client” may refer to a client application or a client device. While a networked system implementing fuel efficient route computation using GPS-based navigation may involve many more components, relevant ones are discussed in conjunction with this figure.

A system for collecting and processing external data for navigation devices may include a number of servers such as server 362 and data stores such as data store 368. Data store 368 may be accessed directly or through database server 364. Input for external data may be provided manually by human operators, automatically by sensor devices, cameras, or other GPS-based devices such as smart phone 366. Applications in server 362 may compile this data and make it available to navigation device 300 through direct communication 374 or indirect communication through another network such as a cellular network represented by the cellular tower 370.

The data may also be provided through wired communications such as dial-up or high speed Internet connections. For example, a driver may plug-in their navigation device to the Internet through their home network before leaving home, at which time the device may receive up-to-date external data and compute the optimal fuel efficient routes for the driver's selection.

Network(s) 3600 may include a secure network such as an enterprise network, an unsecure network such as a wireless open network, or the Internet. Network(s) 360 provide communication between the nodes described herein. By way of example, and not limitation, network(s) 360 may include wired media such as a wired network or direct-wired connection, and wireless media such as acoustic, RF, infrared and other wireless media.

Many other configurations of computing devices, applications, data sources, data distribution systems may be employed to implement optimum fuel efficiency computation using GPS-based navigation. Furthermore, the networked environments discussed in FIG. 3 are for illustration purposes only. Embodiments are not limited to the example applications, modules, or processes.

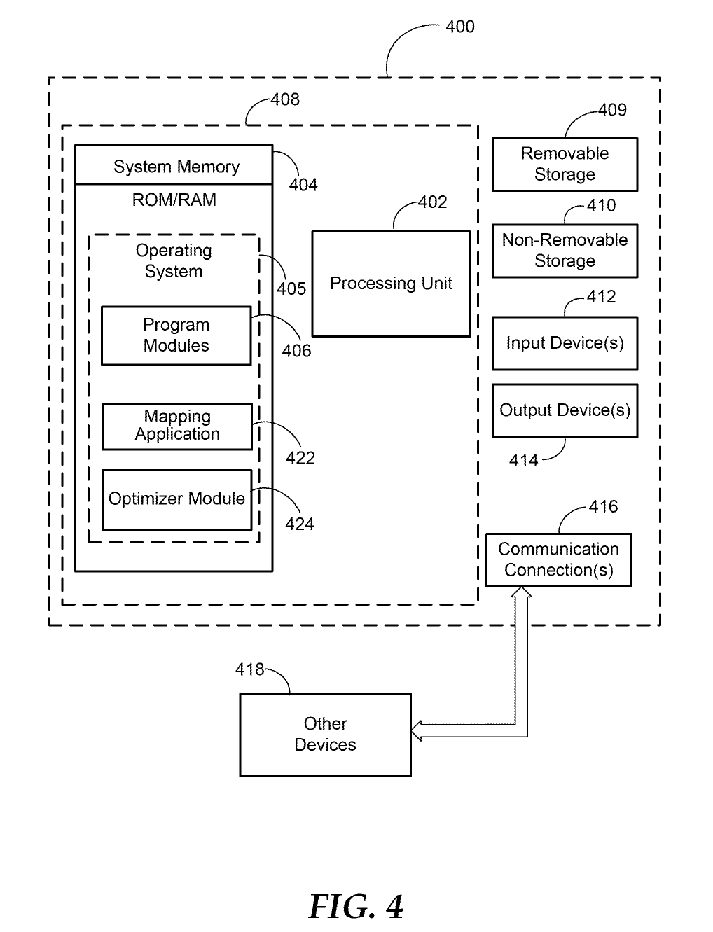

FIG. 4 and the associated discussion are intended to provide a brief, general description of a suitable computing environment in which embodiments may be implemented. With reference to FIG. 4, a block diagram of an example computing operating environment is illustrated, such as navigation device 400. In a basic configuration, the navigation device 400 may be a mobile client device providing fuel efficiency optimized routing based on GPS-aided navigation and typically include at least one processing unit 402 and system memory 404. Navigation device 400 may also include a plurality of processing units that cooperate in executing programs. Depending on the exact configuration and type of computing device, the system memory 404 may be volatile (such as RAM), non-volatile (such as ROM, flash memory, etc.) or some combination of the two. System memory 404 typically includes an operating system 405 suitable for controlling the operation of a networked navigation device, such as the WINDOWS EMBEDDED CE® operating systems from MICROSOFT CORPORATION of Redmond, Washington. The system memory 404 may also include one or more software applications such as program modules 406, mapping application 422, and optimizer module 424.

Mapping application 422 may be a separate application or an integral module of a hosted service that provides GPS-based navigation services to client applications/devices such as navigation device 400. Optimizer module 424 may provide perform route optimization services such as computation of the most fuel efficient route as discussed previously and provide input to mapping application 422 such that the optimum route can be displayed to the driver. This basic configuration is illustrated in FIG. 4 by those components within dashed line 408.

The navigation device 400 may have additional features or functionality. For example, the navigation device 400 may also include additional data storage devices (removable and/or non-removable) such as, for example, magnetic disks, optical disks, or tape. Such additional storage is illustrated in FIG. 4 by removable storage 409 and non-removable storage 410. Computer storage media may include volatile and nonvolatile, removable and non-removable media implemented in any method or technology for storage of information, such as computer readable instructions, data structures, program modules, or other data. System memory 404, removable storage 409 and non-removable storage 410 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by navigation device 400. Any such computer storage media may be part of navigation device 400. Navigation device 400 may also have input device(s) 412 such as keyboard, mouse, pen, voice input device, touch input device, etc. Output device(s) 414 such as a display, speakers, printer, etc. may also be included. These devices are well known in the art and need not be discussed at length here.

The navigation device 400 may also contain communication connections 416 that allow the device to communicate with other devices 418, such as over a wireless network in a distributed computing environment, a satellite link, a cellular link, and the like. Other devices 418 may include server(s) that execute applications associated with a compiling external data, GPS satellites providing GPS data, cellular towers providing external data and/or positioning data. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The claimed subject matter also includes methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

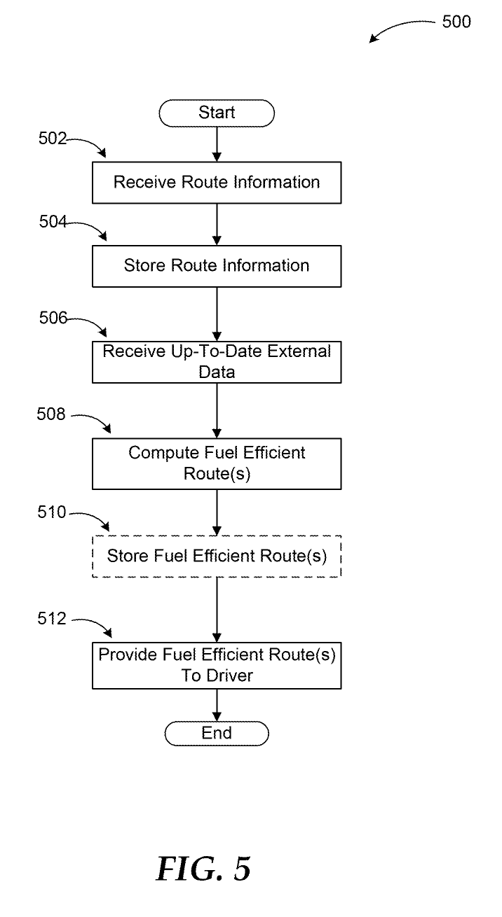

FIG. 5 illustrates a logic flow diagram for a process 500 of facilitating fuel efficiency optimization employing GPS-based navigation. Process 500 may be implemented in a navigation device such as the one described above in conjunction with FIG. 4.

Process 500 begins with operation 502, where original route information is received. The route information may be provided by the driver through manual entry or through automatic recording by the navigation device during travel. Processing advances from operation 502 to operation 504.

At operation 504, the route information is stored in a local or remote data store for future use. Processing moves from operation 504 to operation 506. At operation 506, up-to-date external data is received. As discussed previously, external data may include traffic conditions, weather conditions, road blockages, bridge/railroad crossing opening times, traffic light configurations, actual vehicle fuel consumption, and the like. Processing moves from operation 506 to operation 508.

At operation 508, optimum fuel efficiency route(s) are computed by the navigation device. Fuel efficient routes may be computed using a number of algorithms for individual sections of a multi-stop route or for the whole route. Processing advances from operation 508 to optional operation 510.

At optional operation 510, the computed fuel efficient route(s) are stored. Due to change frequency in up-to-date external data, a fuel efficient route may be valid for a period of time (a day, a week) and, therefore, usable for the driver for that whole period. Thus, it may make sense to store the fuel efficient route for repeated display to the driver until the external data is updated again. Processing moves from optional operation 510 to operation 512.

At operation 512, the computed fuel efficient route is displayed to the driver along with a map of the area. The route may also be provided to the driver using synthesized voice or other means (e.g. a print-out). After operation 512, processing moves to a calling process for further actions.

The operations included in process 500 are for illustration purposes. Facilitating fuel efficiency optimization employing GPS-based navigation may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for providing fuel efficient route optimization employing Global Positioning System (GPS) based navigation, the method comprising:
receiving original route information that includes stops selected by a user;
receiving external data associated with the received route information;
computing at least one fuel efficient route that includes the stops of the original route; and
providing the at least one fuel efficient route to the user by at least one from a set of: displaying a map that includes the fuel efficient route, voice-based directions, and a print-out.

2. The method of claim 1, further comprising:
storing at least one of the original route information and fuel efficient route information.

3. The method of claim 2, further comprising:
associating the stored route information with a user-friendly name for ease of recall by the user.

4. The method of claim 1, wherein receiving the original route information includes at least one of receiving route information by user entry and recording route information during travel.

5. The method of claim 1, wherein the external data includes at least one from a set of: traffic conditions, weather conditions, road conditions, bridge openings, railroad crossing openings, traffic light configurations, and actual vehicle fuel consumption.

6. The method of claim 1, wherein the external data is received through networked communications employing at least one from a set of: a Wireless Local Area Network (WLAN), a Wide Area Network (WAN), a Personal Area Network (PAN), a cellular network, and a dial-up network.

7. The method of claim 1, wherein the fuel efficient route is computed for the whole original route including all stops.

8. The method of claim 1, wherein the fuel efficient route is computed for a portion of the original route including a portion of the stops.

9. The method of claim 1, wherein the computed fuel efficient route is updated based on at least one from a set of: a time of day, a trigger associated with the user, a predefined interval, and receipt of updated external data.

10. The method of claim 1, wherein the fuel efficient route is computed employing one of: a branch-and-bound algorithm, a progressive improvement algorithm, and a heuristic algorithm.

11. A navigation device for providing fuel efficient route optimization employing GPS based navigation, comprising:
a memory;
a processor coupled to the memory, wherein the processor is configured to execute program instructions for:
receiving original route information that includes stops selected by a user through at least one of: receiving route information by user entry and recording route information during travel;
receiving external data associated with the received route information;
computing at least one fuel efficient route that includes the stops of the original route;
storing at least one of the original route information and fuel efficient route information; and
an output device coupled to the processor, wherein the output device is configured to provide at least one from a set of: a display of a map that includes the fuel efficient route, voice-based directions for the fuel efficient route, and a print-out of the fuel efficient route.

12. The navigation device of claim 11, further comprising:
a communication module configure to receive through networked communications employing at least one from a set of: a Wireless Local Area Network (WLAN), a Wide Area Network (WAN), a Personal Area Network (PAN), a cellular network, and a dial-up network.

13. The navigation device of claim 12, wherein the communication module is further configured to receive actual fuel consumption data employing at least one from a set of: serial communication, parallel communication, and optical communication.

14. The navigation device of claim 12, wherein the processor is further configured to execute at least one from a set of: a mapping application, a fuel consumption monitoring application, and a traffic condition display application.

15. The navigation device of claim 12, wherein the device is integrated into one of: a Personal Digital Assistant (PDA), a smart phone, and a smart automobile console.

16. The navigation device of claim 12, wherein the processor is further configured to enable the user to specify a name for each route information stored by the navigation device.

17. A computer-readable storage medium with instructions stored thereon for providing fuel efficient route optimization employing GPS based navigation, the instructions comprising:
receiving original route information that includes stops selected by a user through at least one of: receiving route information by user entry and recording route information during travel;
receiving external data associated with the received route information, wherein the external data includes at least one from a set of: traffic conditions, weather conditions, road conditions, bridge openings, railroad crossing openings, traffic light configurations, and actual vehicle fuel consumption;
computing at least one fuel efficient route that includes the stops of the original route employing one of: an exact solution algorithm and a heuristic algorithm; and
providing the at least one fuel efficient route to the user by at least one from a set of: displaying a map that includes the fuel efficient route, voice-based directions, and a print-out.

18. The computer-readable storage medium of claim 17, wherein the computing the at least one fuel efficient route includes:
computing route stops by determining whether there are any predefined intervals where latitude and longitude data points do not change by more than a predefined tolerance value;
determining a list of ordered stop permutations;
for each stop permutation, computing a fastest route through each stop in that particular route permutation;
representing each stop as a vertex in an undirected graph where each of the computed routes between each stop is represented as a segment in the graph;
associating a value with each segment with a number that is a weighted average between travel times computed for the original route and predicted by the external data; and
computing a solution using the undirected graph as input.

19. The computer-readable storage medium of claim 18, wherein the solution is computed employing one of: an approximation algorithm, a nearest neighbor (NN) algorithm, a pairwise exchange algorithm, a Lin-Kernighan heuristic algorithm, and a Markov chain algorithm.

20. The computer-readable storage medium of claim 17, wherein the fuel efficient route is computed for one of: the whole original route including all stops and a portion of the original route including a portion of the stops.
